(19) United States
(12) Patent Application Publication
(10) Pub. No.: US 2009/0079728 A1
(43) Pub. Date: Mar. 26, 2009

(54) APPARATUS, METHOD, AND COMPUTER PROGRAM PRODUCT FOR GENERATING MULTIVIEW DATA

(76) Inventors: Kaoru Sugita, Saitama (JP); Yasunobu Yamauchi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/052,911

(22) Filed: Mar. 21, 2008

(30) Foreign Application Priority Data
Sep. 25, 2007 (JP) 2007-247994

(51) Int. Cl. G06F 17/00

(52) U.S. Cl. 345/418

(57) ABSTRACT

A multiview-data generating apparatus of the present invention generates, for each pixel index of each pixel included in a predetermined area, a color information group and a depth value group of a CG object corresponding to each viewpoint, derives an approximate function by approximating a relation between the viewpoint and the depth value based on the depth value group, and handles the depth value group in a state of a depth parameter array that is obtained by arranging parameters of the approximate function.

### CROSS-REFERENCE TO RELATED APPLICATIONS

This application is based upon and claims the benefit of priority from the prior Japanese Patent Application No. 2007-247994, filed on Sep. 25, 2007; the entire contents of which are incorporated herein by reference.

### BACKGROUND OF THE INVENTION

1. Field of the Invention

The present invention relates to an apparatus, method, and computer program product for generating multiview data.

2. Description of the Related Art

A computer-graphic (CG) drawing apparatus such as a video device and a game machine usually performs CG rendering in real time to draw three-dimensional CG images of a character and the like. As is disclosed by “REAL-TIME RENDERING Second Edition (Japanese version)”, translated by Hiroyuki Kawanishi, Born Digital, Inc., pp. 269 to 283, 2006 and the like, a technique called “sprite” is known that regards a CG image itself as an image, and texture-maps the image on a polygon plate that form a shape of the CG image to draw the CG image. By using the sprite technique, CG images can be drawn at high speeds without drawing many polygons that configure a three-dimensional character and the like. Accordingly, the sprite technique is particularly useful when a CG image has a complicated shape.

An “appreciator-participation-type 3D video display” by Fukushima and Hirayama, Information Processing, Vol. 47, No. 4, pp. 368 to 373 (2006) and the like disclose a three-dimensional display according to a one-dimensional integral imaging method that can display video images having horizontal parallax by overlaying a lenticular sheet on a liquid crystal display. Also in this three-dimensional display, CG images are drawn in the same manner as in the drawing apparatus mentioned above. In this case, however, plural CG images corresponding to the number of viewpoints must be drawn for each pixel. To draw sprites that provide a three-dimensional appearance to a viewer, texture images that differ according to the viewpoints must be texture-mapped on a polygon panel. In regard to this point, various techniques such as a technique disclosed in JP-A 2004-5228 (KOKAI) are proposed. A technique of drawing texture images that differ according to the viewpoints is hereinafter referred to as “multiview sprite”.

As described above, the multiview sprite enables to draw video images that provide a three-dimensional appearance to the viewer (three-dimensional video images). When the texture images that differ according to the viewpoints are simply attached to the polygon panel, the depth value of the polygon panel may be used instead of an actual depth value of an object corresponding to a three-dimensional image during depth determination at the drawing of the polygon. Particularly, the depth determination is not performed normally between a specific multiview sprite and other multiview sprites, or between a polygon object and multiview sprites.

With regard to a single sprite, “REAL-TIME RENDERING Second Edition (Japanese version)”, translated by Hiroyuki Kawanishi, Born Digital, Inc., pp. 285 to 287 (2006) discloses a technique called “depth sprite” that retains a depth value as a difference from a depth value at which the polygon panel is drawn, in units of pixels of a sprite, in addition to color information, and compensates the depth value in units of pixels at the drawing of the polygon panel, to realize correct depth determination. Also for a multiview sprite, the color information and the depth value can be retained in units of pixels of a texture image at each viewpoint, to perform the depth determination in the same manner as in the depth sprite.

As a typical depth value derivation method, a technique is proposed by “Prototyping and Evaluation of Amusement Oriented Real-time & Interactive 3D Computer Stereography”, Atsushi Miyazawa et al., the Institute of Image Information and Television Engineer, 2006, the Temporary Study Group for Stereoscopic Video Technology, Oct. 17, 2006. This technique performs rendering with respect to one representative viewpoint, creates a color information buffer and a depth value buffer, and subjects the depth value buffer to a ray tracing process in the direction of each pixel on a screen from a new viewpoint, to obtain a pixel position and a depth value on the closest depth value buffer, thereby creating a depth value buffer for each pixel corresponding to the new viewpoint. This corresponds to a method called relief mapping, which is disclosed by “Real-Time Relief Mapping on Arbitrary Polygonal Surfaces”, Fabio Policarpo, et al., ACM I3D, 2005.

However, when the technique disclosed by “REAL-TIME RENDERING Second Edition (Japanese version)”, translated by Hiroyuki Kawanishi, Born Digital, Inc., pp. 285 to 287 (2006) is applied to multiview data, the depth values in units of pixels at each viewpoint must be buffered, so that the memory amount for storing the depth values is increased. The technique disclosed by “Prototyping and Evaluation of Amusement Oriented Real-Time & Interactive 3D Computer Stereography”, Atsushi Miyazawa et al., the Institute of Image Information and Television Engineer, 2006, the Temporary Study Group for Stereoscopic Video Technology, Oct. 17, 2006 must solve an equation of a high-dimensional function to obtain a depth value for each pixel in an image at each viewpoint during drawing. Accordingly, the processing is complicated, and the amount of calculation is increased. Because the depth value buffer is created based on one representative viewpoint, a correct shape cannot be reproduced when there are pixels that are hidden from the viewpoint.

### SUMMARY OF THE INVENTION

According to one aspect of the present invention, a multiview-data generating apparatus includes a first receiving unit that receives an input of multiview camera information including at least information regarding plural different viewpoints and the number of pixels in a frame as a shooting range from each of the viewpoints; a second receiving unit that receives an input of shape data representing a shape and a color of a computer graphic (CG) object; a pixel index generator that successively generates a pixel index of each pixel included in a predetermined area in the frame; a color information generator that generates, based on the multiview camera information and the shape data, a group of color information during shooting of the CG object placed within the frame from the respective viewpoints, for each of the pixel indexes; a depth value generator that generates, based on the multiview camera information and the shape data, a group of depth values during shooting of the CG object placed within the frame from the respective viewpoints, for each of the pixel indexes; a depth-parameter array generator that derives an approximate function by approximating a relation between the respective viewpoints and the group of the depth values, for each of the pixel indexes, and generates a depth parameter array by arranging parameters of the approximate function; and a multiview data generator that generates multiview data corresponding to parallax images according to the number of viewpoints, based on the group of color information and the depth parameter array for each of the pixel indexes.

According to another aspect of the present invention, a multiview-data generating method includes first receiving an input of multiview camera information including at least information regarding plural different viewpoints and the number of pixels in a frame as a shooting range from each of the viewpoints; second receiving an input of shape data representing a shape and a color of a computer graphic (CG) object; successively generating a pixel index of each pixel included in a predetermined area in the frame; generating, based on the multiview camera information and the shape data, a group of color information during shooting of the CG object placed within the frame from the respective viewpoints, for each of the pixel indexes; generating, based on the multiview camera information and the shape data, a group of depth values during shooting of the CG object placed within the frame from the respective viewpoints, for each of the pixel indexes; deriving an approximate function by approximating a relation between the respective viewpoints and the group of the depth values, for each of the pixel indexes, and generating a depth parameter array by arranging parameters of the approximate function; and generating multiview data corresponding to parallax images according to the number of viewpoints, based on the group of color information and the depth parameter array for each of the pixel indexes.

A computer program product according to still another aspect of the present invention causes a computer to perform the method according to the present invention.

### BRIEF DESCRIPTION OF THE DRAWINGS

FIG. 1 is a diagram illustrating a hardware configuration of a multiview-data generating apparatus;

FIG. 2 is a diagram illustrating a configuration of a display unit included in the multiview-data generating apparatus of FIG. 1;

FIG. 3 is a diagram illustrating a functional configuration of a multiview-data generating apparatus according to a first embodiment of the present invention;

FIG. 4 is a diagram illustrating an example of multiview camera information shown in FIG. 3;

FIG. 5 is a schematic diagram for explaining the multiview camera information shown in FIG. 3;

FIG. 6 is a schematic diagram for explaining the multiview camera information shown in FIG. 3;

FIG. 7 is a diagram conceptually illustrating an example of shape data shown in FIG. 3;

FIG. 8 is a flowchart of a procedure a multiview color-information generating process;

FIG. 9 is a schematic diagram for explaining the multiview color-information generating process shown in FIG. 8;

FIG. 10 is a flowchart of a procedure of a multiview depth-value generating process;

FIG. 11 is a flowchart of a procedure of a depth-parameter-array generating process;

FIG. 12 is a schematic diagram for explaining the depth-parameter-array generating process shown in FIG. 11;

FIG. 13 is a flowchart of a procedure of a depth-value restoring process;

FIG. 14 is a flowchart of a procedure of a depth determining process;

FIG. 15 is a flowchart of a procedure of a multiview-data generating process;

FIG. 16 is a diagram illustrating a functional configuration of a multiview-data generating apparatus according to a second embodiment of the present invention;

FIG. 17 is a schematic diagram illustrating a data configuration of integrated multiview sprite data;

FIG. 18 is a flowchart of a procedure of an integrated multiview-sprite-data storing process;

FIG. 19 is a diagram illustrating a functional configuration of a multiview-data generating apparatus according to a third embodiment of the present invention;

FIG. 20 is a diagram illustrating an example of multiview-sprite-display attribute information shown in FIG. 19;

FIG. 21 is a diagram illustrating a relation between a frame and a sprite area; and

FIG. 22 is a flowchart of a procedure of a multiview-data generating process according to a third embodiment of the present invention.

### DETAILED DESCRIPTION OF THE INVENTION

Exemplary embodiments of an apparatus, a method, and a computer program product for generating multiview data according to the present invention will be explained below in detail with reference to the accompanying drawings.

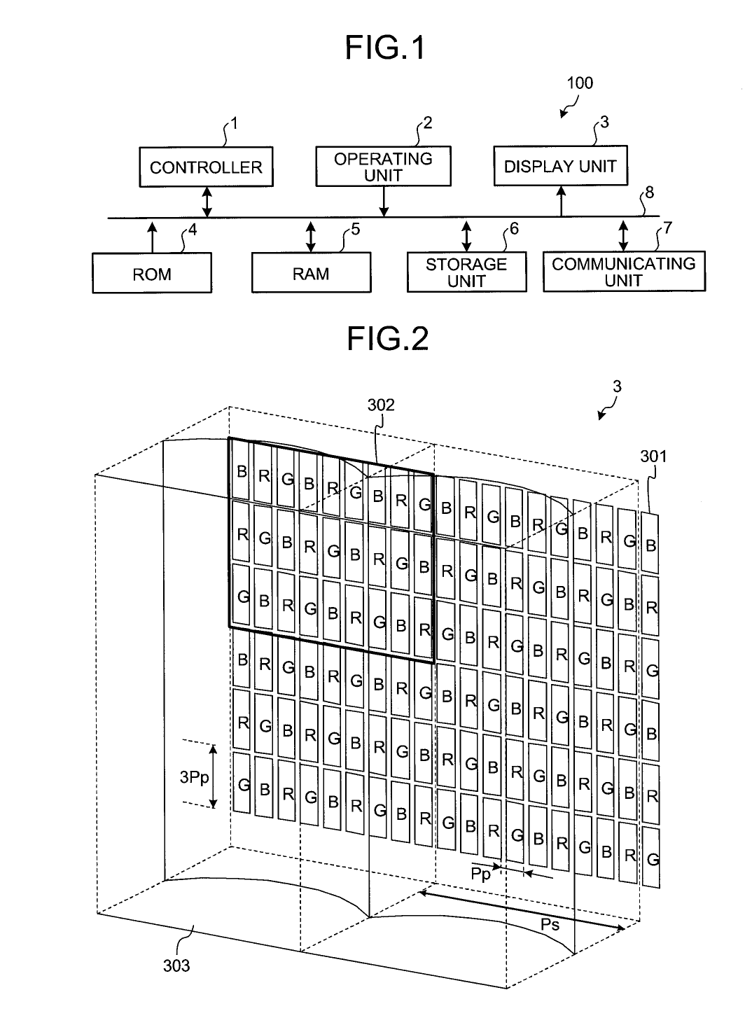

FIG. 1 is a block diagram of a hardware configuration of a multiview-data generating apparatus 100 according to a first embodiment of the present invention. As shown in FIG. 1, the multiview-data generating apparatus 100 includes a controller 1, an operating unit 2, a display unit 3, a read only memory (ROM) 4, a random access memory (RAM) 5, a storage unit 6, a communicating unit 7, and the like, which are connected via a bus 8. Multiview-data generating apparatuses 200 and 300 that will be explained later have the same hardware configuration as that of the multiview-data generating apparatus 100.

The controller 1 is composed of an arithmetic device such as a central processing unit (CPU) and a graphics processing unit (GPU). The controller 1 uses a predetermined area in the RAM 5 as a work area, and performs various processes cooperating with various control programs previously stored in the ROM 4 or the storage unit 6 to integrally control operations of the components that configure the multiview-data generating apparatus 100. The controller 1 realizes operations of functional units which are explained later, cooperating with predetermined programs previously stored in the ROM 4 or the storage unit 6.

The operating unit 2 is an input device such as a mouse and a keyboard. The operating unit 2 receives information inputted by a user as an instruction signal, and outputs the instruction signal to the controller 1.

The display unit 3 has a display device such as a liquid crystal display (LCD), and a ray control element such as a lenticular lens. The display unit 3 is a three-dimensional display system that displays three-dimensional video images corresponding to a predetermined number of viewpoints under control of a display controller 17, which is explained later.

FIG. 2 is a perspective view schematically depicting a configuration of the display unit 3. A case that the number of viewpoints n=9 is illustrated. As shown in FIG. 2, the display unit 3 includes a lenticular plate 303 composed of cylindrical lenses having optical openings extending vertically as a ray control element, in front of a display face on which sub-pixels 301 are arranged in matrix.

On the display face, the sub-pixels 301 each having an aspect ratio of 3:1 are horizontally aligned in a row. The sub-pixels 301 are aligned so that red (R), green (G), and blue (B) are horizontally arranged in turn in a row. The sub-pixels 301 are also vertically aligned in a column. The sub-pixels 301 are aligned so that R, G, and B are arranged in turn in a column. The vertical period (3Pp) of the sub-pixel row is three times the horizontal period Pp of the sub-pixels 301.

In a common color-image display device, the three sub-pixels 301 of R, G, and B that are horizontally arranged forms one effective pixel, i.e., a smallest unit having luminance and color that can be arbitrary set. Accordingly, the aspect ratio of the sub-pixel is 3:1. On the display face as shown in FIG. 2, one effective pixel is formed by the three sub-pixels 301 of R, G, and B that are vertically arranged. Nine columns of effective pixels 302 horizontally arranged (surrounded by a black frame) displays a parallax image corresponding to one cylindrical lens.

The cylindrical lens of the lenticular plate 303 as a ray control element is placed approximately in front of the effective pixel 302. The horizontal pitch (Ps) of the cylindrical lenses is nine times the horizontal period (Pp) of the sub-pixels arranged within the display face. With this configuration, sub-pixels that are seen enlargedly through the cylindrical lens are switched according to changes in the horizontal observation position. That is, how a parallax image displayed on the effective pixel 302 looks is changed, so that the observer can visually recognize a three-dimensional video image.

Returning to FIG. 1, the ROM 4 unrewritably stores programs associated with control of the multiview-data generating apparatus 100, and various kinds of setting information.

The RAM 5 is a volatile storage device such as a synchronous dynamic RAM (SDRAM), and functions as the work area for the controller 1 or a video memory. Specifically, the RAM 5 serves as a multiview-frame depth-value retaining unit 51 or a multiview-frame color-information retaining unit 52, which are explained later. The RAM 5 further works as a buffer that temporarily stores various variables or parameters during processes associated with generation of multiview data.

The storage unit 6 has a magnetically or optically recordable storage medium, and rewritably stores programs associated with control of the multiview-data generating apparatus 100 and various kinds of information. Specifically, the storage unit 6 stores a depth-determination condition expression 61, which is explained later, and the like.

The communicating unit 7 is an interface that establishes communications between external devices. The communicating unit 7 outputs various kinds of received information to the controller 1, and transmits various kinds of information outputted from the controller 1 to the external devices.

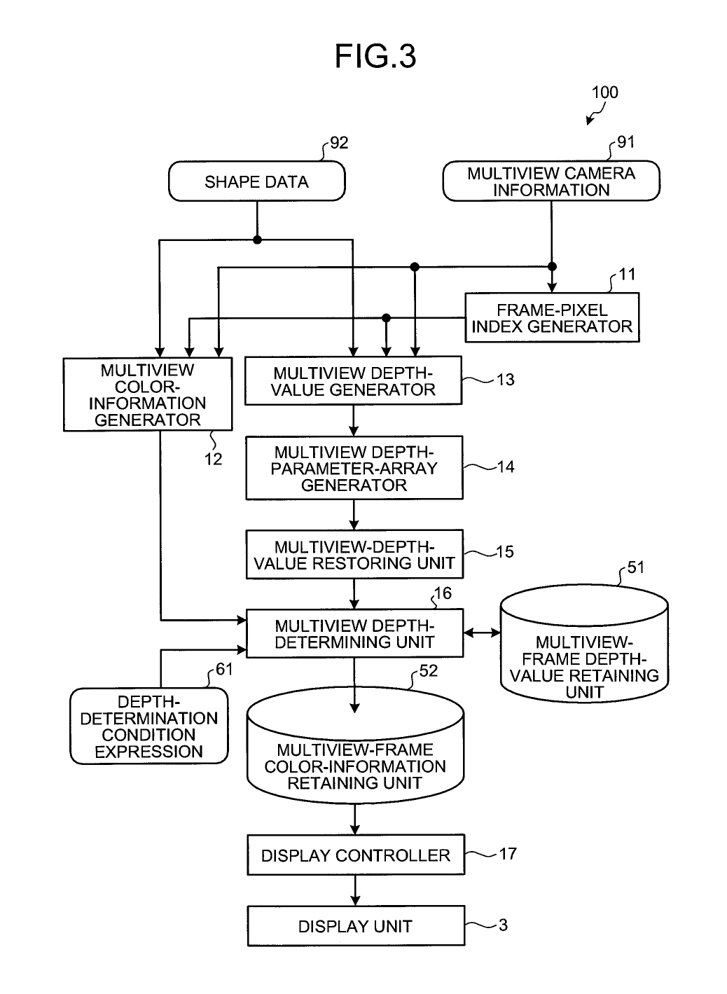

FIG. 3 depicts a functional configuration of the multiview-data generating apparatus 100 according to the first embodiment, which is realized by cooperation between the controller 1 and the predetermined programs previously stored in the ROM 4 or the storage unit 6. As shown in FIG. 3, the multiview-data generating apparatus 100 includes a frame-pixel index generator 11, a multiview color-information generator 12, a multiview depth-value generator 13, a multiview depth-parameter-array generator 14, a multiview-depth-value restoring unit 15, a multiview depth-determining unit 16, and the display controller 17. The RAM 5 achieves functions of the multiview-frame depth-value retaining unit 51 and the multiview-frame color-information retaining unit 52. The storage unit 6 stores the depth-determination condition expression 61.

In the multiview-data generating apparatus 100, a multiview camera information 91, which is explained later, is inputted to the frame-pixel index generator 11, the multiview color-information generator 12, and the multiview depth-value generator 13, before generation of multiview data. Shape data 92, which is explained later, is inputted to the multiview color-information generator 12 and the multiview depth-value generator 13. The way to input the multiview camera information 91 and the shape data 92 is not particularly limited. For example, these data can be inputted from an external device through the communicating unit 7. The multiview camera information 91 and the shape data 92 can be previously stored in the storage unit 6. In this case, the frame-pixel index generator 11, the multiview color-information generator 12, and the multiview depth-value generator 13 can read necessary information from the storage unit 6.

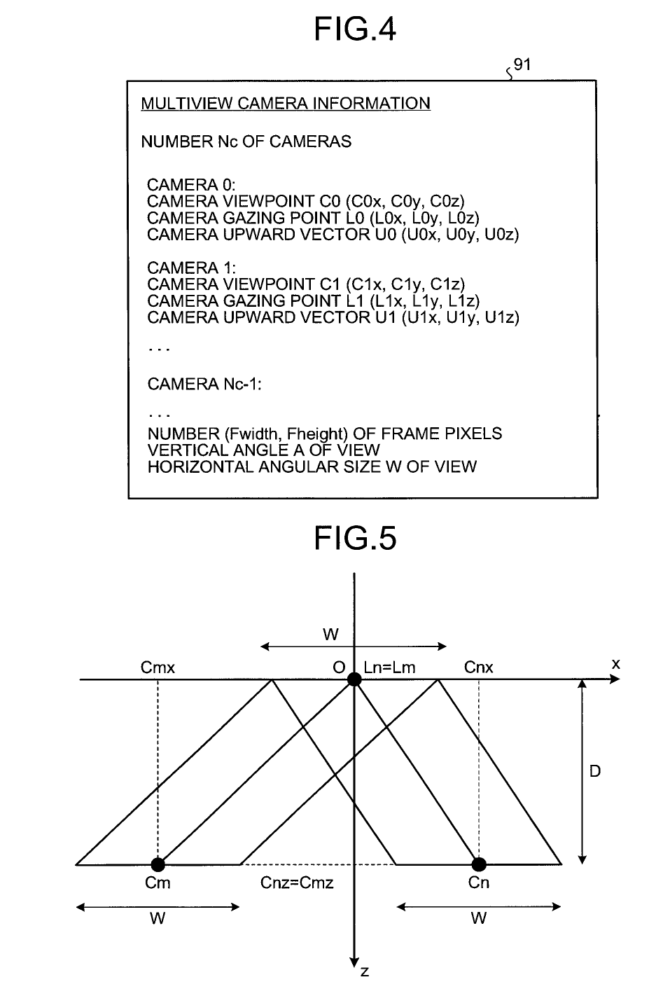

The multiview camera information 91 is explained first with reference to FIGS. 4 to 6. FIG. 4 is an example of the multiview camera information 91. To generate multiview data for presenting a three-dimensional video image, CG images from plural viewpoints must be drawn for each frame. Accordingly, the multiview camera information 91 includes information about plural cameras (camera information) corresponding to viewpoints. In the first embodiment, a parallel-projection lens-shift camera is used for the horizontal direction, and a perspective projection camera is used for the vertical direction. However, the present invention is not limited thereto, and the cameras can be changed according to specifications of a three-dimensional display.

As shown in FIG. 4, the multiview camera information 91 defines the total number Nc of cameras corresponding to the total number of viewpoints. A camera viewpoint Cn that indicates the position of shooting by the camera, A camera gazing point Ln that indicates the orientation of the camera, and an upward vector Un that indicates the top and bottom (upside and downside) of the camera are defined for each of cameras (cameras 0 to Nc−1).

The multiview camera information 91 defines the number Fheight of pixels in the vertical direction of a frame, and the number Fwidth of pixels in the horizontal direction, as the numbers of pixels in a frame. The vertical angle A of view and the horizontal angular size W of view, which are common to the all cameras, are also defined. The horizontal angular size W of view indicates a width of the frame horizontally projected.

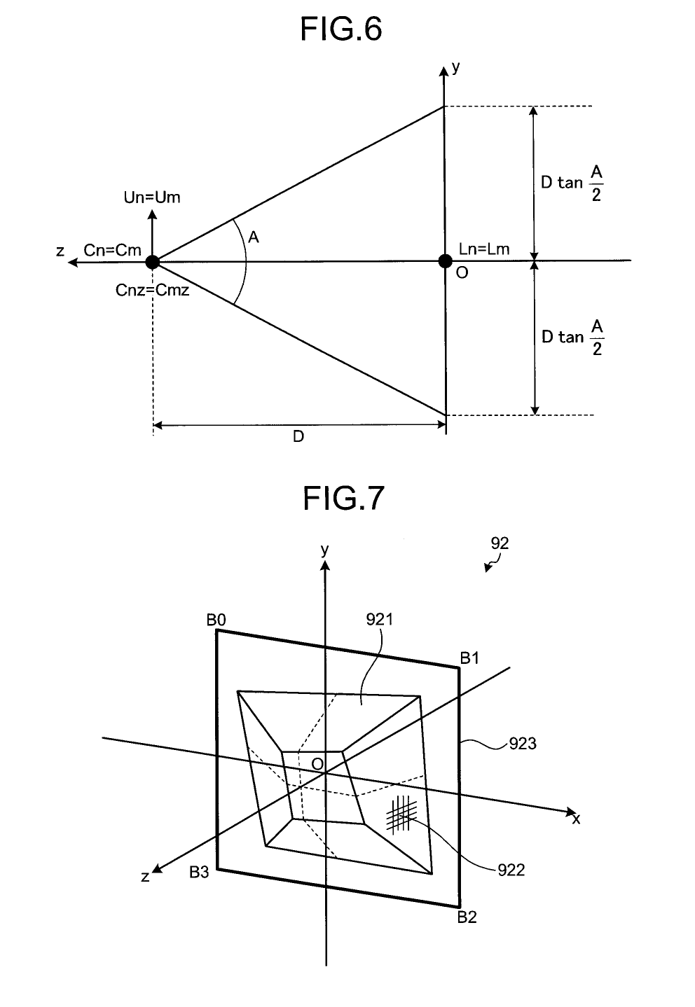

FIGS. 5 and 6 are schematic diagrams for explaining the various kinds information included in the multiview camera information 91. FIG. 5 depicts a XZ plane seen from right above the camera. FIG. 6 depicts a YZ plane seen from a side of the camera.

FIGS. 5 and 6 depict relations between camera viewpoints Cm and Cn of two cameras, i.e., mth and nth cameras among Nc cameras, and a frame that is an area to be shot by these cameras. This example assumes a case that a frame is on a XY plane, and the center of the frame is the origin O. The viewpoints of the cameras are on the XZ plane, and Cm=(Cmx, 0, D) and Cn=(Cnx, 0, D). In this case, “D” indicates a Z component of a distance between the frame and the camera. That is, the vertical angle of view of the frame is represented by 2×Dtan(A/2).

The angular size W of view in the horizontal direction (the direction of the X axis), which is derived from the positional relations between the camera viewpoints Cm and Cn and the frame, is represented as in FIG. 5, because the parallel projection lens-shift camera is used. The angle A of view in the vertical direction (the direction of the Y axis) is represented as in FIG. 6, because the perspective projection camera is used. The gazing points Ln of all the cameras are the origin O, and the upward vectors of all the cameras are U0=U1 . . . Um=Un . . . =U(0, 1, 0).

The shape data 92 is explained with reference to FIG. 7. FIG. 7 conceptually depicts an example of the shape data 92. As shown in FIG. 7, the shape data 92 defines a CG object 921 that is represented by a group of polygons having multangular shapes, a texture image 922 that is mapped on a surface of the polygon of the CG object 921, a reference frame 923 that is a reference scale for the CG object 921, and the like.

In the example of FIG. 7, the reference frame 923 is on the XY plane, and the four corners are denoted by B0, B1, B2, and B3. The CG object 921 is in a three-dimensional space on the reference frame 923, and its shape is convex in the Z-axis direction.

A three-dimensional shape represented by the CG object 921 and a surface image represented by the texture image 922 correspond to a three-dimensional video image presented by the display unit 3. The shape of the CG object 921, and the color and pattern of the texture image 922 can be arbitrarily set. A three-dimensional object defined by the shape data 92 is not limited to one, and plural three-dimensional objects can be defined. The number of pieces of the shape data to be inputted is not limited to one, and plural pieces of shape data can be successively inputted. In this case, a multiview color-information generating process and a multiview depth-value generating process, which are explained later, are performed at each input of the shape data.

Returning to FIG. 3, the frame-pixel index generator 11 receives input of the multiview camera information 91, and successively generates coordinate components (index) of each pixel included in the frame based on the multiview camera information 91, to successively output a frame pixel index Fi (Fi=(Px, Py)) to the multiview color-information generator 12 and the multiview depth-value generator 13.

Specifically, the frame-pixel index generator 11 refers to the number (Fwidth, Fheight) of pixels in the frame defined in the multiview camera information 91, and successively generates and outputs indexes corresponding to all the pixels included in the frame. For example, in the case of (Fwidth, Fheight)=(320, 240), the frame-pixel index generator 11 outputs the frame pixel indexes Fi from (Px, Py)=(0, 0) corresponding to the upper left of the frame to (Px, Py)=(319, 239) corresponding to the lower right of the frame, i.e., (Px, Py)=(0, 0), . . . , (319, 0), (0, 1), . . . , (319, 1), . . . , (0, 239), . . . , (319, 239), one by one in this order.

The multiview color-information generator 12 receives input of the multiview camera information 91, the shape data 92, and the frame pixel index Fi, and derives a frame-pixel index-corresponding point Fp by mapping the frame pixel index Fi on the reference frame 923 defined in the shape data 92, based on the inputted information.

The multiview color-information generator 12 derives each intersection Qn at which a straight line connecting the frame-pixel index-corresponding point Fp and each of the camera viewpoints Cn intersects a polygonal surface of the CG object 921 defined in the shape data 92.

The multiview color-information generator 12 obtains color information (multiview color information) Color(n) for each of the derived intersections Qn, i.e., each of the camera viewpoints Cn, to be related to the inputted frame pixel index Fi and outputted to the multiview depth-determining unit 16.

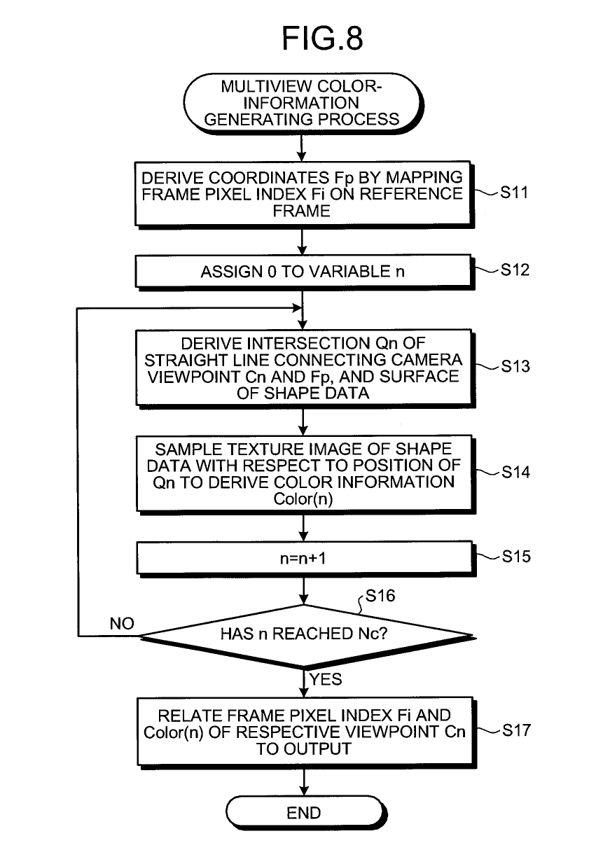

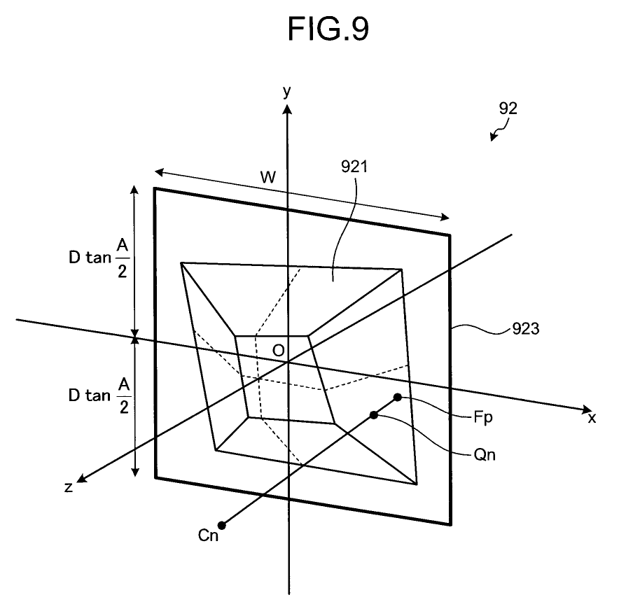

The operation of the multiview color-information generator 12 is explained with reference to FIGS. 7, 8, and 9. FIG. 8 is a flowchart of a procedure of a multiview color-information generating process performed by the multiview color-information generator 12. FIG. 9 is a schematic diagram for explaining a result obtained by performing the multiview color-information generating process to the shape data 92 shown in FIG. 7. The multiview color-information generating process is a common ray tracing process performed for a camera at each viewpoint.

Based on the reference frame 923 of the shape data 82, the multiview color-information generator 12 derives coordinates Fp (Fp=(Fx, Fy, Fz)) by mapping the frame pixel index Fi on the reference frame 923 (step S11). The coordinates Fp are hereinafter referred to as the frame-pixel index-corresponding point Fp.

For example when the shape data 92 has a state as shown in FIG. 9, the reference frame 923 is on the XY plane. Accordingly, a z component (Fz) of the frame-pixel index-corresponding point Fp is 0. In this case, the frame-pixel index-corresponding point Fp can be derived by using the following equation (1).

$$\begin{matrix}Fp = ( Fx , Fy , Fz ) \\ = ( \frac{Px * W}{Fwidth} - \frac{W}{2 ,} - \frac{2 Py}{Fheight} * D tan \frac{A}{2} + D tan \frac{A}{2 ,} 0 )\end{matrix} \qquad ( 1 )$$

Next, the multiview color-information generator 12 assigns 0 to a variable n for calculating the camera viewpoint Cn, to initialize the variable n (step S12).

Based on the multiview camera information 91 and the shape data 92, the multiview color-information generator 12 derives an intersection Qn (Qn=(Qnx, Qny, Qnz)) at which the straight line connecting the camera viewpoint Cn corresponding to the variable n and the frame-pixel index-corresponding point Fp intersects a polygonal surface of the CG object 921 defined in the shape data 92 (step S13).

The process at step S13 is explained with reference to FIG. 9. It is assumed that the camera viewpoint Cn and the frame-pixel index-corresponding point Fp are located at positions as shown in FIG. 9. At this time, the multiview color-information generator 12 obtains an intersection at which a straight line connecting the camera viewpoint Cn and the frame-pixel index-corresponding Fp intersects a polygonal surface configuring the CG object 921, as the intersection Qn. When there are plural intersections, one of the intersections having a smallest distance between the camera viewpoint Cn and the frame-pixel index-corresponding point Fp is obtained as the intersection Qn.

Returning to FIG. 8, the multiview color-information generator 12 samples the texture image 922 defined in the shape data 92 with respect to the position of the intersection Qn derived at step S13, and derives color information corresponding to the position of the intersection Qn, i.e., color information Color(n) corresponding to the camera viewpoint Cn (step S14). The color information includes components of red (R), green (G), and blue (B). That is, Color(n)=(ColorR(n), ColorG(n), ColorB(n)).

The multiview color-information generator 12 then increments the variable n by one (step S15), and determines whether the variable n has reached the total number Nc of cameras (step S16). When it is determined that n<Nc (NO at step S16), the processing returns to step S13, to derive the intersection Qn with respect to the next viewpoint.

When determining that n=Nc (YES at step S16), the multiview color-information generator 12 outputs (Fi, (Color(0), Color(1), . . . , Color(Nc−1)) that is obtained by relating the frame pixel index Fi and the color information Color(n) with respect to the respective camera viewpoints Cn, to the multiview depth-determining unit 16 (step S17), and terminates the processing. A group of the color information Color(n) with respect to the respective camera viewpoints Cn is hereinafter referred to as multiview color information.

Returning to FIG. 3, the multiview depth-value generator 13 receives input of the multiview camera information 91, the shape data 92, and the frame pixel index Fi, and derives the frame-pixel index-corresponding point Fp as mentioned above, based on the inputted information.

The multiview depth-value generator 13 derives the intersection Qn at which the straight line connecting the frame-pixel index-corresponding point Fp and each of the camera viewpoints Cn intersects a polygonal surface of the CG object 921 defined in the shape data 92.

The multiview depth-value generator 13 obtains a depth value dn with respect to each of the derived intersections Qn, to be related to the frame pixel index Fi and outputted to the multiview depth-parameter-array generator 14.

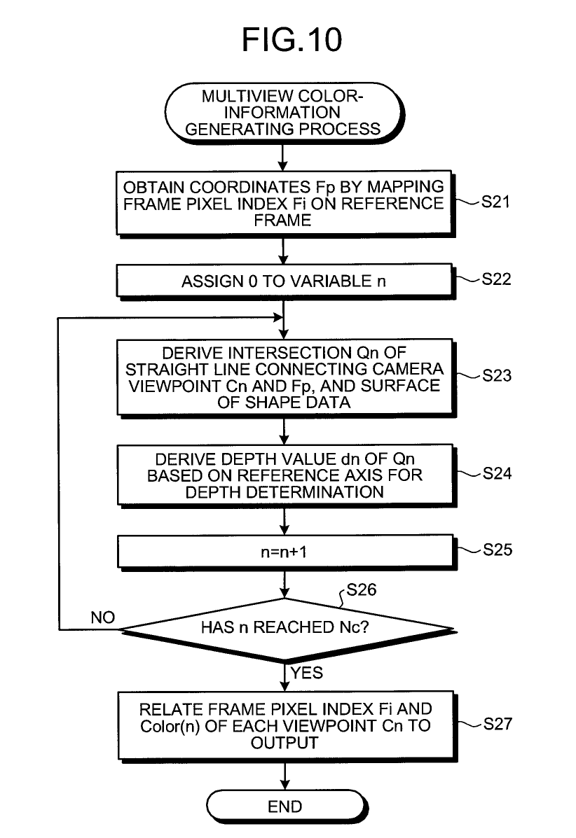

The operation of the multiview depth-value generator 13 is explained with reference to FIGS. 9 and 10. FIG. 10 is a flowchart of a procedure of a multiview depth-value generating process performed by the multiview depth-value generator 13. In the multiview depth-value generating process, a common ray tracing process is performed for a camera at each viewpoint, like in the multiview color-information generating process.

Based on the shape data 92, the multiview depth-value generator 13 derives the coordinates Fp by mapping the frame pixel index Fi on the reference frame 923 defined in the shape data 92, i.e., the frame-pixel index-corresponding point Fp (step S21). The way to derive the frame-pixel index-corresponding pixel Fp is the same as in the multiview color-information generator 12, and thus detailed explanations thereof will be omitted.

The multiview depth-value generator 13 assigns 0 to the variable n for calculating the camera viewpoint Cn, to initialize the variable n (step S22).

Based on the multiview camera information 91 and the shape data 92, the multiview depth-value generator 13 derives a point at which the straight line connecting the camera viewpoint Cn corresponding to the variable n and the frame-pixel index-corresponding point Fp intersects a polygonal surface defined in the shape data 92, as an intersection Qn (step S23). When there are plural intersections, one of the intersections having a smallest distance between the camera viewpoint Cn and the frame-pixel index-corresponding point Fp is obtained as the intersection Qn.

The multiview depth-value generator 13 derives a depth value dn of the intersection Qn in a three-dimensional space on the reference frame 923 defined in the shape data 92, based on a reference axis as a reference for depth determination (step S24).

For example, when the shape data 92 has the state as shown in FIG. 9, the depth of the CG object 921 can be represented with reference to the Z axis. In this case, a Z component of the intersection Qn is a depth value. Accordingly, “−Qnz” is derived as the depth value dn by inverting the sign of the Z component of Qn=(Qnx, Qny, Qnz). In this case, a point that is nearer to the viewpoint has a smaller depth value, and a point that is farther from the viewpoint has a larger depth value.

Returning to FIG. 10, the multiview depth-value generator 13 increments the variable n by one (step S25), and determines whether the variable n has reached the total number Nc of cameras (step S26). When it is determined that n<Nc (NO at step S26), the processing returns to step S23 to derive the intersection Qn with respect to the next viewpoint.

When determining that n=Nc (YES at step S26), the multiview depth-value generator 13 relates the frame pixel index Fi and the depth values corresponding to the respective intersections Qn, i.e., the depth values dn with respect to the respective camera viewpoints Cn, to output (Fi, (d0, d1, . . . , dNc−1)) to the multiview depth-parameter-array generator 14 (step S27), and terminates the processing. A group of the depth values dn with respect to the respective camera viewpoints Cn is hereinafter referred to as a multiview depth value.

The frame-pixel index-corresponding point Fp and the intersection Qn derived in the processes at steps S21 and S23 are the same as the frame-pixel index-corresponding point Fp and the intersections Qn derived in the processes at steps S11 and S13 in the multiview color-information generating process. Therefore, the frame-pixel index-corresponding point Fp or the intersection Qn that are obtained in either one of the processes can be utilized in the other process.

Returning to FIG. 3, the multiview depth-parameter-array generator 14 receives input of a set of the frame pixel index Fi and the multiview depth value outputted from the multiview depth-value generator 13, and defines a graph representing the respective camera viewpoints Cn and a sequence of the depth values dn included in the multiview depth value, using a function D(n).

The multiview depth-parameter-array generator 14 derives a function E(n) that is an approximate expression representing the function D(n), and regards a set of parameters included in the function E(n) as a depth parameter array, to be related to the frame pixel index Fi and outputted to the multiview-depth-value restoring unit 15.

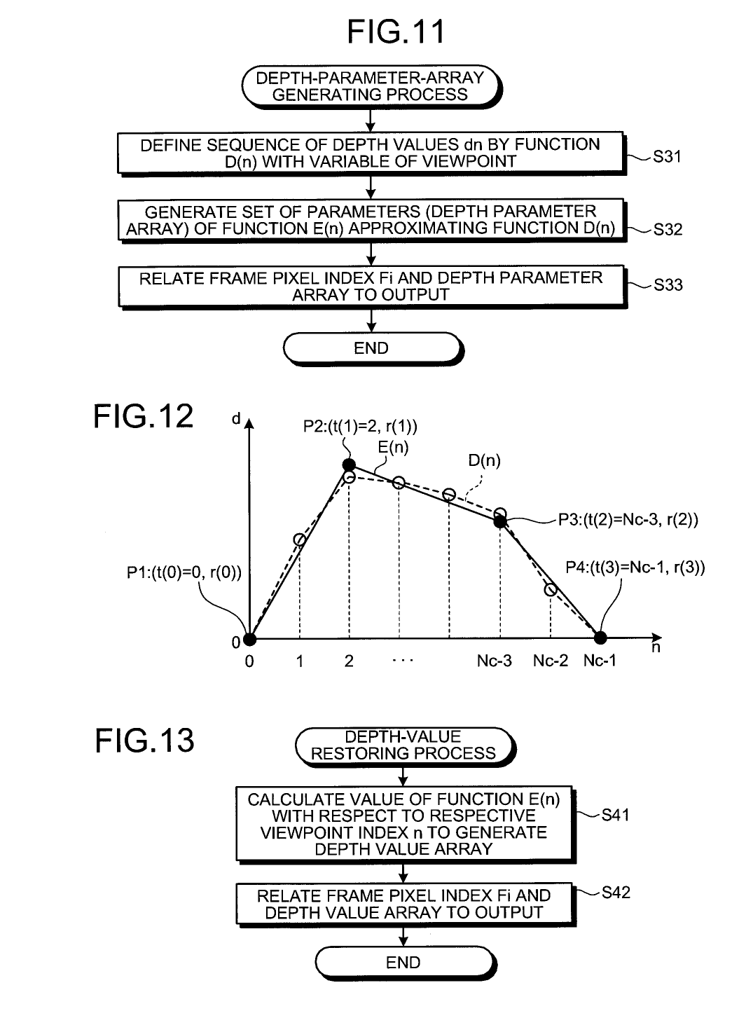

The operation of the multiview depth-parameter-array generator 14 is explained with reference to FIGS. 11 and 12. FIG. 11 is a flowchart of a procedure of a depth-parameter-array generating process performed by the multiview depth-parameter-array generator 14.

The multiview depth-parameter-array generator 14 defines a sequence of the depth values dn included in the multiview depth value by the function D(n) with a variable of a viewpoint index n corresponding to each camera viewpoint (step S31). The multiview depth-parameter-array generator 14 derives the function E(n) that is an approximate expression of the function D(n) defined at step S31, and generates a set of parameters that configures the function E(n) (step S32).

FIG. 12 is a schematic diagram for explaining the processes at steps S31 and S32 in the depth-parameter-array generating process. In FIG. 12, the vertical axis represents the depth value, and the horizontal axis represents the camera viewpoint Cn (0=n=Nc−1). It is assumed here that an array of the depth values dn included in the multiview depth value has a state shown by white circles in FIG. 12. In the process at step S31, a graph that is obtained by connecting these white circles in the ascending order of n is defined by the function D(n) with the viewpoint index n representing each camera viewpoint as a variable (corresponding to a dash line connecting the white circles in FIG. 12).

In the process at step S32, a set of parameters of the function E(n) that is an approximate expression of the function D(n) is obtained. For example, when the function E(n) is a piecewise linear expression obtained by connecting plural control points Pn=(t(n), r(n)), i.e., piecewise linear function, the parameters of the function E(n) is (t(n), r(n)).

A graph in full line of FIG. 12 represents the function E(n) when the number of the control points Pn is four. Components of the control points P1 to P4 are (t(0), r(0)), (t(1), r(1)), (t(2), r(2)), and (t(3), r(3)), respectively. In this case, t(n) indicates a viewpoint index corresponding to each camera viewpoint Cn, and r(n) indicates the depth value dn corresponding to t(n).

In FIG. 12, t(0) of the control point P1 is the camera viewpoint CO (t(0)=0), t(1) of the control point P2 is the camera viewpoint C2 (t(1)=2), t(2) of the control point P3 is the camera viewpoint CNc−3 (t(2)=Nc−3), and t(3) of the control point P4 is the camera viewpoint CNc−1 (t(3)=Nc−1). That is, the graph represented by a set of the Nc−1 depth values dn is approximated by a piecewise linear function formed by connecting the four control points.

The method of deriving the respective values of the depth parameter array (t(n), r(n)) is not particularly limited. For example, the following method can be employed. The number Np of the control points is previously determined, and t(0), t(1), . . . , t(Np−1) are assigned to viewpoint indexes between 0 and Nc−1. It is assumed that r(0)=D(0) and r(Np−1)=D(Nc−1), and values satisfying the following equation (2) are used for r(1) to r(Np−2). In this equation, k denotes an integer that is 0 or larger.

$$r ( k + 1 ) = argmin [ ( {\sum }_{i = t ( k )}^{t ( k + 1 ) - 1} \frac{( D ( i ) + D ( i + 1 ) )}{2} ) - \frac{( t ( k + 1 ) - t ( k ) ) * ( r ( k + 1 ) + r ( k ) )}{2} ] \qquad ( 2 )$$

The method of assigning t(n) to the camera viewpoints is not particularly limited. For example, t(n) can be assigned at regular intervals in a range where changes in the depth values are small. The number of t(n) to be assigned can be changed according to the magnitude of the changes in the depth values dn.

Returning to FIG. 11, the multiview depth-parameter-array generator 14 relates the frame pixel index Fi and the depth parameter array (t(n), r(n)), to output (Fi, (t(0), r(0)), (t(1), r(1)), . . . ) to the multiview-depth-value restoring unit 15 (step S33), and terminates the processing.

In the depth-parameter-array generating process, the depth values dn corresponding to the respective camera viewpoints Cn are converted into a set of parameters of the function E(n), thereby representing the depth values in unit of pixels with respect to the respective camera viewpoints with a smaller amount of data.

In the first embodiment, the function E(n) representing an approximate expression of the function D(n) is a group of linear expressions. However, the present invention is not limited thereto. A Bezier function or a spline function can be employed. A high-dimensional function such as a quadratic function and a cubic function can be used.

Returning to FIG. 3, the multiview-depth-value restoring unit 15 receives input of the set of the frame pixel index Fi and the depth parameter array, outputted from the multiview depth-parameter-array generator 14, and generates a depth value array by arranging values of the function E(n) with respect to the viewpoint indexes n representing the respective camera viewpoints.

The multiview-depth-value restoring unit 15 relates the generated depth value array to the frame pixel index Fi, to be outputted to the multiview depth-determining unit 16.

The operation of the multiview-depth-value restoring unit 15 is explained with reference to FIG. 13. FIG. 13 is a flowchart of a procedure of a depth-value restoring process performed by the multiview-depth-value restoring unit 15.

Based on the inputted depth parameter array (t(n), r(n)), the multiview-depth-value restoring unit 15 calculates values of the function E(n) with respect to the respective viewpoint indexes n corresponding to the camera viewpoints Cn, and generates a depth value array (E(0), E(1), . . . , E(Nc−1)) by arranging these values (step S41).

The multiview-depth-value restoring unit 15 relates the frame pixel index Fi and the depth value array (E(0), E(1), . . . , E(Nc−1)), to output (Fi, (E(0), E(1), . . . , E(Nc−1))) to the multiview depth-determining unit 16 (step S42), and terminates the processing.

Returning to FIG. 3, the multiview depth-determining unit 16 receives input of the multiview color information and the depth value array, each being related to the frame pixel index Fi, and assigns a relation between the depth value E(n) included in the depth value array and the depth value retained in the multiview-frame depth-value retaining unit 51 with respect to each camera viewpoint Cn to the depth-determination condition expression 61, which is explained later, to determine whether the relation is true.

When a result of the determination by the depth-determination condition expression 61 is true, the multiview depth-determining unit 16 relates the inputted depth value E(n) to a pixel of a drawing frame, which is explained later, corresponding to the frame pixel index Fi and the camera viewpoint Cn of the depth value E(n), to be retained (stored) in the multiview-frame depth-value retaining unit 51. The multiview depth-determining unit 16 relates the color information included in the multiview color information corresponding to the frame pixel index Fi and the camera viewpoint Cn of the depth value E(n) to a pixel of the drawing frame corresponding to the frame pixel index Fi and the camera viewpoint Cn of the color information, to be retained (stored) in the multiview-frame color-information retaining unit 52.

The multiview-frame depth-value retaining unit 51 is a buffer area corresponding to a Z buffer in the frame buffer. With respect to a drawing frame prepared for each camera viewpoint Cn, the multiview-frame depth-value retaining unit 51 retains (stores) depth values in units of pixels corresponding to the frame pixel index Fi included in each drawing frame. The multiview-frame color-information retaining unit 52 is a buffer area corresponding to a color buffer in the frame buffer. With respect to a drawing frame prepared for each camera viewpoint Cn, the multiview-frame color-information retaining unit 52 retains (stores) color information in units of pixels corresponding to the frame pixel index F included in the drawing frame.

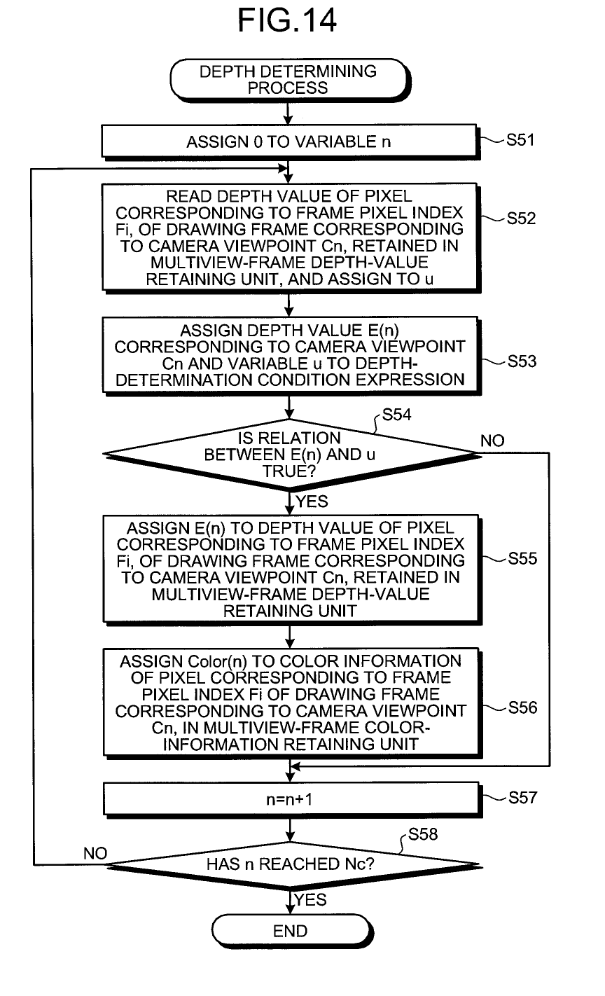

The operation of the multiview depth-determining unit 16 is explained with reference to FIG. 14. FIG. 14 is a flowchart of a procedure of a depth determining process performed by the multiview depth-determining unit 16.

This process assumes that depth values indicating infinite distances for all pixels included in the drawing frames of the multiview-frame depth-value retaining unit 51 are previously retained. It is also assumed that color information indicating background colors (for example, transparent) at the drawing for all pixels included in the drawing frames of the multiview-frame color-information retaining unit 52 is previously retained.

The multiview depth-determining unit 16 assigns 0 to the variable n for calculating the camera viewpoint Cn (step S51). The multiview depth-determining unit 16 reads a depth value of a pixel corresponding to the frame pixel index Fi, in a drawing frame corresponding to the camera viewpoint Cn retained in the multiview-frame depth-value retaining unit 51, and assigns the depth value to a variable u (step S52).

The multiview depth-determining unit 16 assigns a depth value E(n) corresponding to the camera viewpoint Cn of the frame pixel index Fi as the present process target and the variable u to the depth-determination condition expression 61 (step S53), and determines whether the condition of the depth-determination condition expression 61 is satisfied (step S54).

The depth-determination condition expression 61 is a relational expression for determining an anteroposterior relation associated with the depth between the variable u and the depth value E(n), seen from the camera viewpoint Cn corresponding to the variable n. For example, when a smaller value retained in the multiview-frame depth-value retaining unit 51 indicates that a pixel is closer to the camera viewpoint, the depth-determination condition expression 61 is “E(n)<u”. In the first embodiment, “E(n)<u” is used as the depth-determination condition expression 61. However, the present invention is not limited thereto.

When the depth-determination condition expression 61 is false, i.e., “E(n)=u” (NO at step S54), a process at step S57 is directly performed. When the depth-determination condition expression 61 is true, i.e., “E(n)<u” (YES at step S54), the processing proceeds to step S55.

The multiview depth-determining unit 16 assigns E(n) to the depth value of the pixel corresponding to the frame pixel index Fi, of the drawing frame corresponding to the camera viewpoint Cn, in the multiview-frame depth-value retaining unit 51, to store the value (step S55).

The multiview depth-determining unit 16 assigns Color(n) to the color information of the pixel corresponding to the frame pixel index Fi, of the drawing frame corresponding to the camera viewpoint Cn, in the multiview-frame color-information retaining unit 52, to store the value (step S56).

The multiview depth-determining unit 16 increments the variable n by one (step S57), and determines whether the variable n has reached the total number Nc of cameras (step S58). When it is determined that n<Nc (NO at step S58), the processing returns to step S52. When it is determined that n=Nc (YES at step S58), the processing is terminated.

Returning to FIG. 3, the display controller 17 generates multiview data by the number of parallax images corresponding to the number of camera viewpoints Cn, i.e., corresponding to the entire frame, based on the color information in units of pixels of the drawing frame corresponding to each camera viewpoint, retained in the multiview-frame color-information retaining unit 52.

The display controller 17 displays the generated multiview data on the display unit 3 as a three-dimensional display system, to present a three-dimensional video image according to the shape data 92.

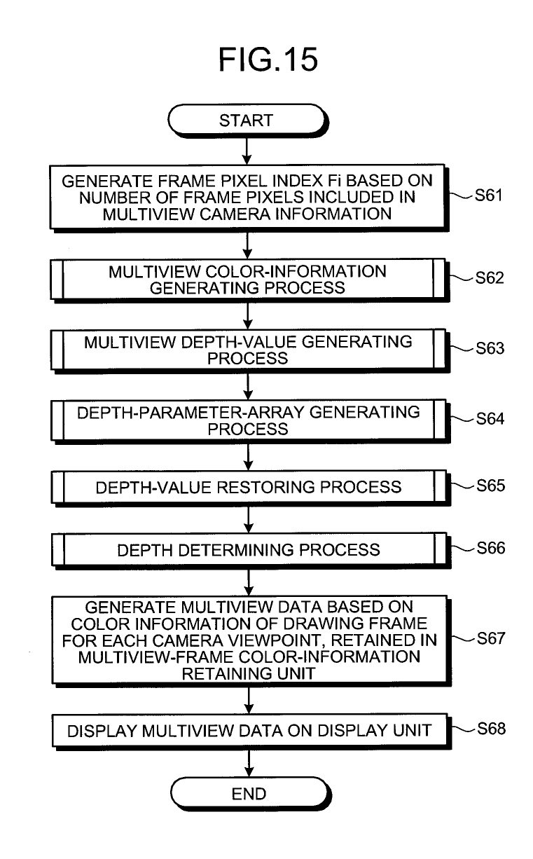

A multiview-data generating process performed by the functional units in the multiview-data generating apparatus 100 is explained with reference to FIG. 15. FIG. 15 is a flowchart of a procedure of a multiview-data generating process.

When the multiview camera information 91 and the shape data 92 are inputted, the frame-pixel index generator 11 generates a frame pixel index Fi based on information about the number of pixels in a frame included in the multiview camera information 91, to output the frame pixel index Fi to the multiview color-information generator 12 and the multiview depth-value generator 13 (step S61).

The multiview color-information generator 12 performs the multiview color-information generating process explained with reference to FIG. 8 based on the multiview camera information 91, the shape data 92, and the frame pixel index Fi, and outputs information of a set of the frame pixel index Fi and the multiview color information to the multiview depth-determining unit 16 (step S62).

The multiview depth-value generator 13 performs the multiview depth-value generating process explained with reference to FIG. 10 based on the multiview camera information 91, the shape data 92, and the frame pixel index Fi, and outputs information of a set of the frame pixel index Fi and the multiview depth value to the multiview depth-parameter-array generator 14 (step S63).

The multiview depth-parameter-array generator 14 performs the depth-parameter-array generating process explained with reference to FIG. 11 based on the information inputted from the multiview depth-value generator 13, and outputs information of a set of the frame pixel index Fi and the depth parameter array to the multiview-depth-value restoring unit 15 (step S64).

The multiview-depth-value restoring unit 15 performs the depth-value restoring process explained with reference to FIG. 13 based on the information inputted from the multiview depth-parameter-array generator 14, and outputs information of a set of the frame pixel index Fi and the depth value array to the multiview depth-determining unit 16 (step S65).

The multiview depth-determining unit 16 performs the depth determining process explained with reference to FIG. 14 based on the information inputted from the multiview-depth-value restoring unit 15, and stores the depth value of a pixel corresponding to each frame pixel index Fi for a frame of each camera viewpoint Cn in the multiview-frame depth-value retaining unit 51. The multiview depth-determining unit 16 also stores color information of the pixel corresponding to each frame pixel index Fi in the multiview-frame color-information retaining unit 52 (step S66).

The display controller 17 generates multiview data corresponding to the total number of camera viewpoints Cn, based on the color information in units of pixels included in the drawing frame for each camera viewpoint Cn, retained in the multiview-frame color-information retaining unit 52 (step S67). The display controller 17 displays the multiview data on the display unit 3 to present a three dimensional video image according to the shape data 92 (step S68), and terminates the processing.

According to the first embodiment, with respect to the shape data 92 of the CG object 921, the depth values in units of pixels for each viewpoint are handled in a state of a depth parameter array that is obtained by arranging parameters of the function E(n) as an approximate expression. This reduces the memory usage, and suppresses loads relating to the calculation. Accordingly, the depth values in units of pixels at each viewpoint can be efficiently derived.

After the depth values are restored from the depth parameter array, the depth determination in units of pixels is performed with respect to each viewpoint. The multiview data that is drawn based on the color information in units of pixels at each viewpoint, obtained from the determination result, is displayed on the display unit 3. Accordingly, a high-accuracy three-dimensional video image can be presented, and the accuracy of the approximation can be visually confirmed.

A multiview-data generating apparatus according to a second embodiment of the present invention is explained next. Like constituent elements as those in the first embodiment are denoted by like reference numerals, and explanations thereof will be omitted.

In the first embodiment, multiview data in units of frames are generated based on the inputted multiview camera information 91 and the shape data 92. In the second embodiment, a multiview-data generating apparatus 200 that generates multiview data in units of sprites is explained. A hardware configuration of the multiview-data generating apparatus 200 is the same as that in the multiview-data generating apparatus 100, and thus explanations thereof will be omitted.

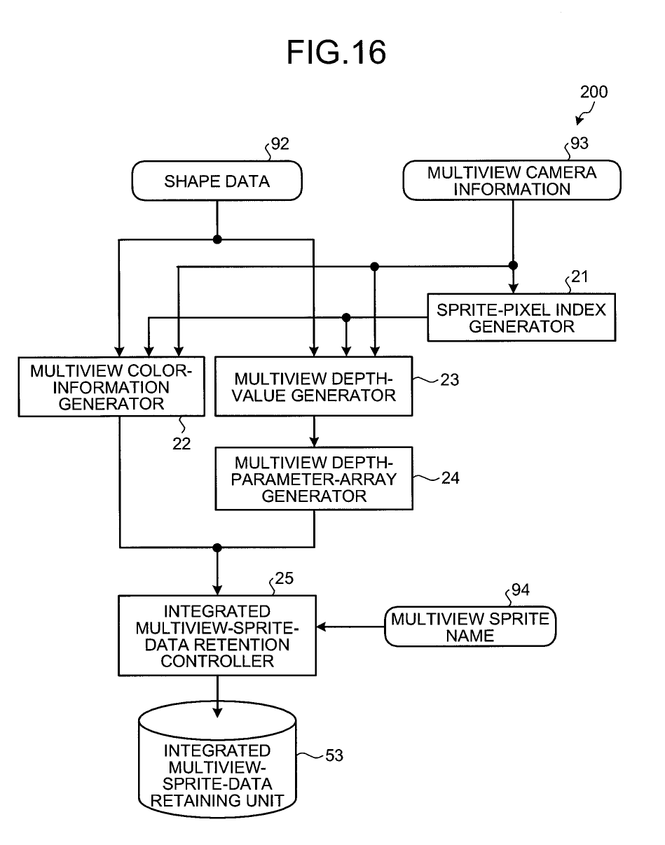

FIG. 16 depicts a functional configuration of the multiview-data generating apparatus 200 according to the second embodiment, which is achieved by cooperation of the controller 1 and the predetermined programs previously stored in the ROM 4 or the storage unit 6. As shown in FIG. 16, the multiview-data generating apparatus 200 includes a sprite-pixel index generator 21, a multiview color-information generator 22, a multiview depth-value generator 23, a multiview depth-parameter-array generator 24, and an integrated multiview-sprite-data retention controller 25. The RAM 5 implements a function of an integrated multiview-sprite-data retaining unit 53.

In the multiview-data generating apparatus 200, multiview camera information 93 is inputted to the sprite-pixel index generator 21, the multiview color-information generator 22, and the multiview depth-value generator 23. The shape data 92 is inputted to the multiview color-information generator 22 and the multiview depth-value generator 23.

The multiview camera information 93 includes the number of sprite pixels (Swidth, Sheight) defining the number of pixels Sheight in the vertical direction of a sprite area and the number of pixels Swidth in the horizontal direction thereof, instead of the number of frame pixels (Fwidth, Fheight). When a frame is equal to a sprite area, the multiview camera information 93 is the same as the multiview camera information 91 employed in the first embodiment.

The sprite-pixel index generator 21 receives input of the multiview camera information 93, and generates an index of each pixel in the sprite area based on the multiview camera information 93, to successively output a sprite pixel index Si (Si=(Sx, Sy)).

Specifically, the sprite-pixel index generator 21 refers to the number (Swidth, Sheight) of pixels in the sprite area included in the multiview camera information 93, and successively outputs components (sprite pixel indexes) of all pixels included in the sprite area. For example, when (Swidth, Sheight)=(200, 100), the sprite-pixel index generator 21 successively outputs (Sx, Sy)=(0, 0), . . . , (199, 0), (0, 1), . . . , (199, 1), . . . , (0, 99), . . . , (199, 99), one by one, from (Sx, Sy)=(0, 0) corresponding to the upper left of the sprite area to (Sx, Sy)=(199, 99) corresponding to the lower right of the sprite area, in this order.

The multiview color-information generator 22 has the same function as that of the multiview color-information generator 12. Based on the multiview camera information 93, the shape data 92, and the sprite pixel index Si, the multiview color-information generator 22 derives a sprite-pixel index-corresponding point Sp by mapping the sprite pixel index Si on the reference frame 923 defined in the shape data 92.

The multiview color-information generator 22 derives an intersection Qn at which a straight line connecting the sprite-pixel index-corresponding point Sp and each of the camera viewpoints Cn intersects a polygonal surface of the CG object 921 defined in the shape data 92.

The multiview color-information generator 22 obtains color information Color(n) for the respective derived intersections Qn, i.e., multiview color information, and relates the multiview color information to the sprite pixel index Si to be outputted to the integrated multiview-sprite-data retention controller 25.

The multiview color-information generating process performed by the multiview color-information generator 22 is the same as the multiview color-information generating process performed by the multiview color-information generator 12, which has been explained in the first embodiment. Accordingly, explanations thereof will be omitted.

The multiview depth-value generator 23 has the same function as that of the multiview depth-value generator 13. Based on the multiview camera information 93, the shape data 92, and the sprite pixel index Si, the multiview depth-value generator 23 derives the sprite-pixel index-corresponding point Sp.

The multiview depth-value generator 23 derives the intersection Qn at which the straight line connecting the sprite-pixel index-corresponding point Sp and each of the camera viewpoints Cn intersects the polygonal surface of the CG object 921 defined in the shape data 92.

The multiview depth-value generator 23 derives depth values dn for the respective derived intersections Qn, i.e., a multiview depth value, and relates the multiview depth value to the sprite pixel index Si to be outputted to the multiview depth-parameter-array generator 24.

The multiview depth-value generating process performed by the multiview depth-value generator 23 is the same as the multiview depth-value generating process performed by the multiview depth-value generator 13, which has been explained in the first embodiment. Accordingly, explanations thereof will be omitted.

The multiview depth-parameter-array generator 24 has the same function as that of the multiview depth-parameter-array generator 14. The multiview depth-parameter-array generator 24 receives input of a set of the sprite pixel index Si and the multiview depth value, defines a graph represented by a sequence of the depth values dn included in the multiview depth value using a function D(n), and derives a function E(n) that is an approximate expression of the function D(n).

The multiview depth-parameter-array generator 24 regards a set of parameters included in the function E(n) as a depth parameter array, and relates the depth parameter array to the sprite pixel index Si to be outputted to the integrated multiview-sprite-data retention controller 25.

The multiview depth-parameter-array generating process performed by the multiview depth-parameter-array generator 24 is the same as the multiview depth-parameter-array generating process performed by the multiview depth-parameter-array generator 14, which has been explained in the first embodiment. Thus, explanations thereof will be omitted.

The integrated multiview-sprite-data retention controller 25 receives input of the set of the sprite pixel index Si and the multiview color information, outputted from the multiview color-information generator 22, and the sprite pixel index Si and the depth parameter array outputted from the multiview depth-parameter-array generator 24.

With respect to a given multiview sprite name 94, the integrated multiview-sprite-data retention controller 25 relates each sprite pixel index Si and the corresponding multiview color information and depth parameter array, as integrated multiview sprite data, and stores the integrated multiview sprite data in the integrated multiview-sprite-data retaining unit 53. The integrated multiview-sprite-data retaining unit 53 is a predetermined storage area (video memory, or the like) in the RAM 5. In the second embodiment, the RAM 5 serves as the integrated multiview-sprite-data retaining unit 53. However, the present invention is not limited thereto, and the storage unit 6 can serves as the integrated multiview-sprite-data retaining unit 53. The multiview sprite name 94 can be externally inputted through the communicating unit 7. Alternatively, the multiview sprite name 94 can be automatically given at the generation of the integrated multiview sprite data by the integrated multiview-sprite-data retention controller 25.

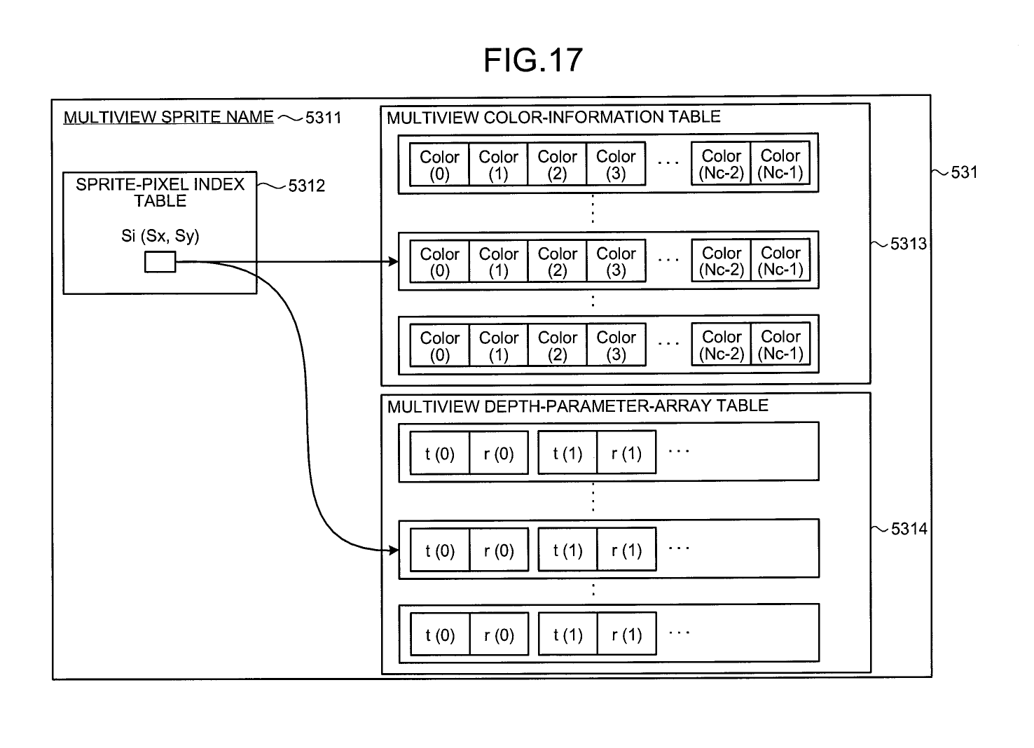

FIG. 17 schematically depicts a data configuration of integrated multiview sprite data 531 retained by the integrated multiview-sprite-data retaining unit 53. As shown in FIG. 17, the integrated multiview sprite data 531 includes a multiview sprite name 5311, a sprite-pixel index table 5312, a multiview color-information table 5313, and a multiview depth-parameter-array table 5314.

The multiview sprite name 5311 corresponds to the multiview sprite name 94, and is identification information for identifying the integrated multiview sprite data 531. A unique character string is preferably given to each of the integrated multiview sprite data 531, as the multiview sprite name 5311.

The sprite-pixel index table 5312 stores the sprite pixel indexes Si. The multiview color-information table 5313 stores the multiview color information Color(n). The multiview depth-parameter-array table 5314 stores the depth parameter array (t(n), r(n)).

The multiview color information Color(n) and the depth parameter array (t(n), r(n)) stored in the multiview color-information table 5313 and the multiview depth-parameter-array table 5314, respectively, are stored related to the corresponding sprite pixel index Si, stored in the sprite-pixel index table 5312.

That is, based on the sprite pixel index Si stored in the sprite-pixel index table 5312, the multiview color information Color(n) and the depth parameter array (t(n), r(n)) corresponding to the sprite pixel index Si can be read from the multiview color-information table 5313 and the multiview depth-parameter-array table 5314, respectively. Arrows in FIG. 17 indicate the multiview color information Color(n) and the depth parameter array (t(n), r(n)) corresponding to one sprite pixel index Si.

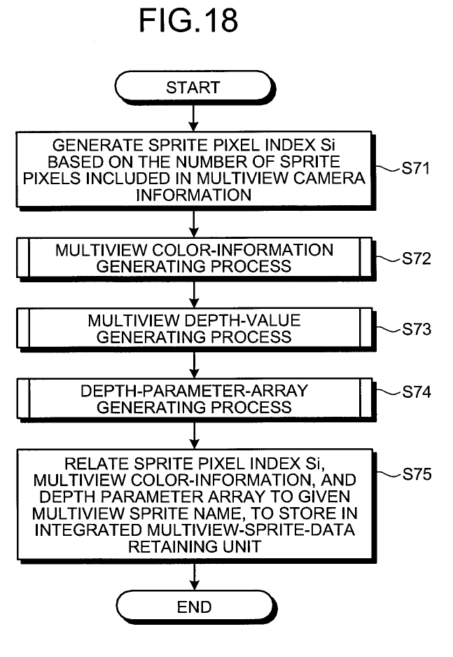

The integrated multiview-sprite-data storing process performed by the functional units of the multiview-data generating apparatus 200 is explained with reference to FIG. 18. FIG. 18 is a flowchart of a procedure of the integrated multiview-sprite-data storing process.

When the multiview camera information 93 and the shape data 92 are inputted, the sprite-pixel index generator 21 successively generates the sprite pixel index Si based on information about the number of pixels in a sprite included in the multiview camera information 93, and outputs the sprite pixel index Si to the multiview color-information generator 22 and the multiview depth-value generator 23 (step S71).

Based on the multiview camera information 93, the shape data 92, and the sprite pixel index Si, the multiview color-information generator 22 performs the same process as the multiview color-information generating process explained with reference to FIG. 8 for the sprite pixel index Si. The multiview color-information generator 22 outputs information of a set of the sprite pixel index Si and the multiview color information to the integrated multiview-sprite-data retention controller 25 (step S72).

Based on the multiview camera information 93, the shape data 92, and the sprite pixel index Si, the multiview depth-value generator 23 performs the same process as the multiview depth-value generating process explained with reference to FIG. 10 for the sprite pixel index Si. The multiview depth-value generator 23 relates the multiview depth value obtained in this process to the sprite pixel index Si, to be outputted to the multiview depth-parameter-array generator 24 (step S73).

The multiview depth-parameter-array generator 24 performs the same process as the depth-parameter-array generating process explained with reference to FIG. 11, for the sprite pixel index Si, based on the information inputted from the multiview depth-value generator 23. The multiview depth-parameter-array generator 24 relates the depth parameter array obtained in this process to the sprite pixel index Si, to be outputted to the integrated multiview-sprite-data retention controller 25 (step S74).

The integrated multiview-sprite-data retention controller 25 relates the sets of the sprite pixel index Si, and the multiview color-information and the depth parameter array inputted from the multiview color-information generator 22 and the multiview depth-parameter-array generator 24, respectively, to the multiview sprite name 94. The integrated multiview-sprite-data retention controller 25 stores the related data in the integrated multiview-sprite-data retaining unit 53 as the integrated multiview sprite data (step S75), and terminates the processing.

As described above, according to the second embodiment, with respect to the shape data 92 of the CG object 921, the depth values in units of pixels for each viewpoint are handles in a state of the depth parameter array that is obtained by arranging the parameters of the function E(n) as an approximate expression. This reduces the memory usage, and suppresses the load relating to the calculation. Accordingly, the depth values in units of pixels for each viewpoint can be efficiently derived.

The integrated multiview sprite data including the sets of the sprite pixel index Si, and the multiview color information and the depth parameter array, which are related to one multiview sprite name, are retained in the integrated multiview-sprite-data retaining unit 53. Accordingly, the depth values in units of pixels for each viewpoint can be efficiently retained without increasing the amount of memory or calculation.

A multiview-data generating apparatus according to a third embodiment of the present invention is explained. Like constituent elements as those in the first and second embodiments are denoted by like reference numerals, and explanations thereof will be omitted.

In the third embodiment, a multiview-data generating apparatus 300 that generates multiview data for three-dimensional video display, by using the multiview sprite data generated by the multiview-data generating apparatus 200 according to the second embodiment is explained. A hardware configuration of the multiview-data generating apparatus 300 is the same as that of the multiview-data generating apparatus 100. Therefore, explanations thereof will be omitted.

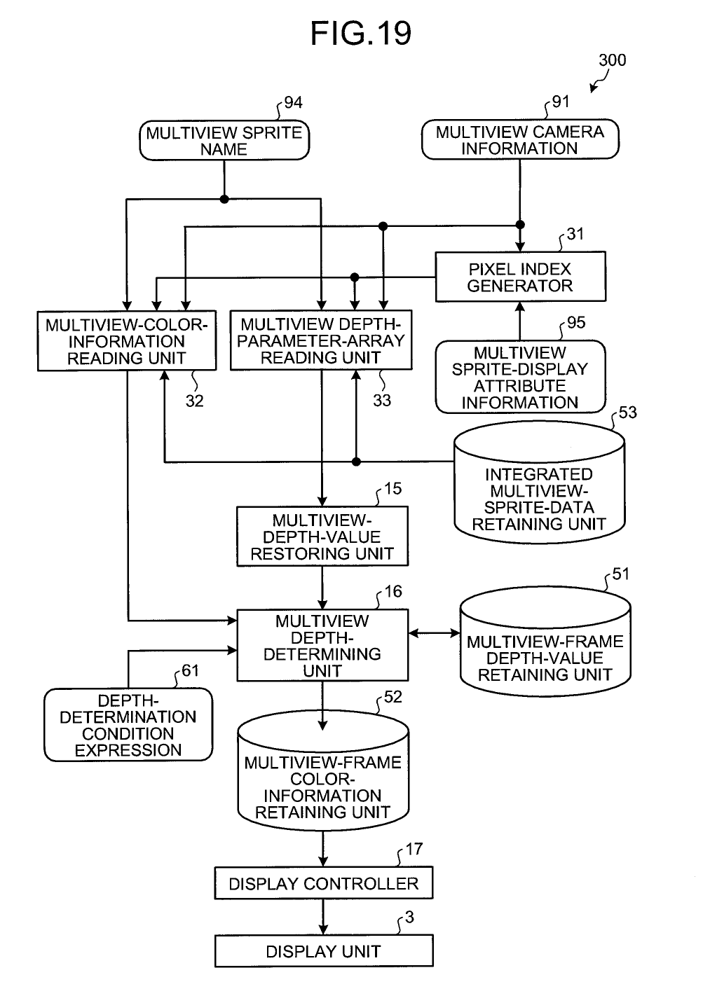

FIG. 19 depicts a functional configuration of the multiview-data generating apparatus 300 according to the third embodiment, which is implemented by cooperation of the controller 1 and the predetermined programs previously stored in the ROM 4 or the storage unit 6. As shown in FIG. 19, the multiview-data generating apparatus 300 includes a pixel index generator 31, a multiview-color-information reading unit 32, a multiview depth-parameter-array reading unit 33, the multiview-depth-value restoring unit 15, the multiview depth-determining unit 16, and the display controller 17. The RAM 5 achieves the functions of the multiview-frame depth-value retaining unit 51, the multiview-frame color-information retaining unit 52, and the integrated multiview-sprite-data retaining unit 53. The storage unit 6 stores the depth-determination condition expression 61.

In the multiview-data generating apparatus 300, before generating multiview data, the multiview camera information 91 is inputted to the pixel index generator 31, the multiview-color-information reading unit 32, and the multiview depth-parameter-array reading unit 33.

The multiview sprite name 94 is inputted to the multiview-color-information reading unit 32 and the multiview depth-parameter-array reading unit 33, as instruction information for reading specific integrated multiview sprite data from the integrated multiview-sprite-data retaining unit 53. The multiview sprite name 94 can be inputted from an external device through the communicating unit 7. Alternatively, the multiview sprite name 94 can be previously stored in the storage unit 6, and read from the storage unit 6 by the multiview-color-information reading unit 32 and the multiview depth-parameter-array reading unit 33.

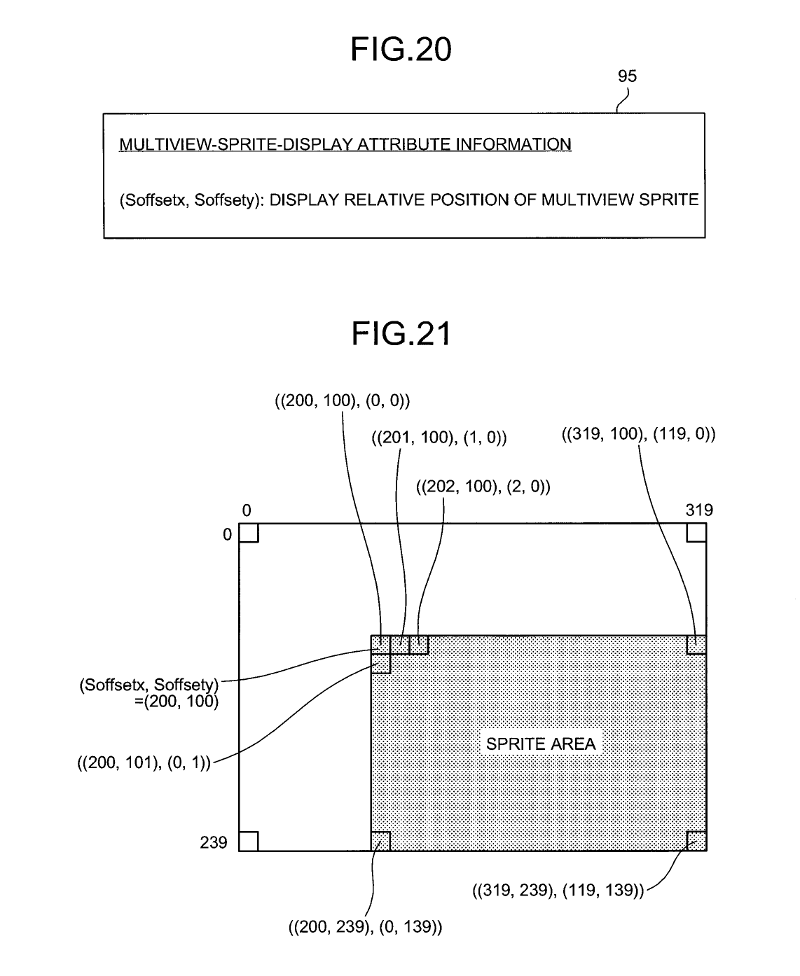

Multiview-sprite-display attribute information 95 that defines attributes for displaying the multiview sprite data is inputted to the pixel index generator 31. The multiview-sprite-display attribute information 95 is explained with reference to FIG. 20.

FIG. 20 is an example of the multiview-sprite-display attribute information 95. As shown in FIG. 20, the multiview-sprite-display attribute information 95 defines a display relative position (Soffsetx, Soffsety) indicating a relative display position (sprite area) of a multiview sprite in a frame. In the third embodiment, the multiview-sprite-display attribute information 95 includes only the display relative position. However, the present invention is not limited thereto. A display size of the multiview sprite (scaling parameter) or a parameter for affine transform can be included.

Returning to FIG. 19, the pixel index generator 31 generates a pixel index Gi related to the sprite pixel index Si and the frame pixel index Fi corresponding to the sprite pixel index Si, based on the multiview camera information 91 and the multiview-sprite-display attribute information 95, to output the pixel index Gi to the multiview-color-information reading unit 32 and the multiview depth-parameter-array reading unit 33.

Specifically, based on the number (Fwidth, Fheight) of pixels in a frame included in the multiview camera information 91 and the display relative position (Soffsetx, Soffsety) of the multiview-sprite-display attribute information 95, the pixel index generator 31 relates the sprite pixel index Si and the frame pixel index Fi corresponding to the sprite pixel index Si, to successively outputs the pixel indexes Gi=((Px, Py), (Sx, Sy)) for all pixels in the sprite area. The frame pixel index Fi is not outputted for pixels that do not correspond to pixels in the sprite area among the pixels included in the frame.

As shown in FIG. 21, it is assumed that the number of frame pixels is (Fwidth, Fheight)=(320, 240), and the multiview-sprite-display attribute information 95 defines (Soffsetx, Soffsety)=(200, 100). In this case, as the pixel index Gi=((Px, Py), (Sx, Sy)), the pixel index generator 31 successively outputs ((Px, Py), (Sx, Sy))=((200, 100), (0, 0)), ((201, 100), (1, 0)), ((202, 100), (2, 0)), . . . , ((319, 100), (119, 0)), ((200, 101), (0, 1)), . . . , ((200, 239), (0, 139)), . . . , ((319, 239), (119, 139)).

Returning to FIG. 19, the multiview-color-information reading unit 32 refers to the integrated multiview sprite data 531 corresponding to the multiview sprite name 94 from the integrated multiview-sprite-data retaining unit 53, and reads the multiview color information Color(n) corresponding to (Sx, Sy) of the pixel index Gi=((Px, Py), (Sx, Sy)) inputted from the pixel index generator 31, from the multiview color-information table 5313.

The multiview-color-information reading unit 32 relates the read multiview color information Color(n) to (Px, Py) of the pixel index Gi, i.e., the frame pixel index Fi corresponding to (Sx, Sy), to be outputted to the multiview depth-determining unit 16.

The multiview depth-parameter-array reading unit 33 refers to the integrated multiview sprite data 531 corresponding to the multiview sprite name 94 from the integrated multiview-sprite-data retaining unit 53, and reads the depth parameter array (t(n), r(n)) corresponding to (Sx, Sy) of the pixel index Gi=((Px, Py), (Sx, Sy)) inputted from the pixel index generator 31, from the multiview depth-parameter-array table 5314.

The multiview depth-parameter-array reading unit 33 relates the read depth parameter array (t(n), r(n)) to (Px, Py) of the pixel index Gi, i.e., the frame pixel index Fi corresponding to (Sx, Sy), to be outputted to the multiview-depth-value restoring unit 15.

The multiview-depth-value restoring unit 15 generates a depth value array based on a set of the frame pixel index Fi and the depth parameter array (t(n), r(n)) inputted from the multiview depth-parameter-array reading unit 33, and relates the depth value array to the pixel index Gi to be outputted to the multiview depth-determining unit 16. The multiview depth-value restoring process performed by the multiview-depth-value restoring unit 15 is the same as the multiview depth-value restoring process explained in the first embodiment. Accordingly, explanations thereof will be omitted.

Based on the frame pixel index Fi, and the multiview color information Color(n), and the depth parameter array (t(n), r(n)) inputted from the multiview-color-information reading unit 32 and the multiview-depth-value restoring unit 15, the multiview depth-determining unit 16 determines a depth with respect to each camera viewpoint Cn for each pixel corresponding to the frame pixel index Fi. The depth determining process performed by the multiview depth-determining unit 16 is the same as the depth determining process explained in the first embodiment. Thus, explanations thereof will be omitted.

When the processes for sets of all the frame pixel indexes Fi (including the sprite pixel indexes Si) are completed by the functional units, the display controller 17 generates, based on the color information in units of pixels in the drawing frame corresponding to each camera viewpoint, multiview data corresponding to parallax images according to the number of the camera viewpoints Cn, i.e., an entire frame including the multiview data of the sprite area (multiview sprite data).

The display controller 17 displays the generated multiview data on the display unit 3 as a three-dimensional display system, to present the entire frame in a state where a three-dimensional video image (multiview sprite data) is drawn at a part corresponding to the sprite area.

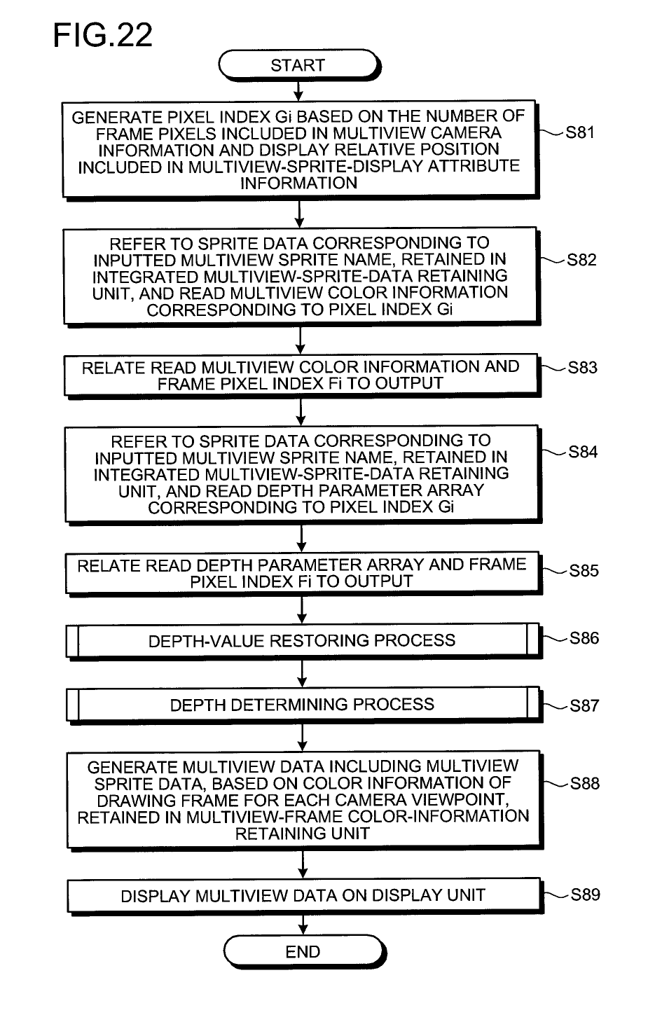

A multiview-data generating process performed by the functional units of the multiview-data generating apparatus 300 is explained with reference to FIG. 22. FIG. 22 is a flowchart of a procedure of a multiview-data generating process.

When the multiview camera information 91, the multiview sprite name 94, and the multiview-sprite-display attribute information 95 are inputted, the pixel index generator 31 generates, based on the multiview camera information 91 and the multiview-sprite-display attribute information 95, the pixel index Gi that are the sprite pixel index Si and the frame pixel index Fi corresponding to the sprite pixel index Si being related to each other, and outputs the pixel index Gi to the multiview-color-information reading unit 32 and the multiview depth-parameter-array reading unit 33 (step S81).

The multiview-color-information reading unit 32 refers to the integrated multiview sprite data 531 corresponding to the multiview sprite name 94, retained in the integrated multiview-sprite-data retaining unit 53, and reads the multiview color information corresponding to the sprite pixel index Si included in the pixel index Gi from the multiview color-information table 5313 (step S82).

The multiview-color-information reading unit 32 relates the multiview color information read at step S82 to the frame pixel index Fi included in the pixel index Gi, to be outputted to the multiview depth-determining unit 16 (step S83).

The multiview depth-parameter-array reading unit 33 refers to the integrated multiview sprite data 531 corresponding to the multiview sprite name 94, retained in the integrated multiview-sprite-data retaining unit 53, and reads the depth parameter array corresponding to the sprite pixel index Si included in the pixel index Gi, from the multiview depth-parameter-array table 5314 (step S84).

The multiview depth-parameter-array reading unit 33 relates the depth parameter array read at step S84 to the frame pixel index Fi included in the pixel index Gi, to be outputted to the multiview-depth-value restoring unit 15 (step S85).

The multiview-depth-value restoring unit 15 performs the depth-value restoring unit explained with reference to FIG. 13 based on the information inputted from the multiview depth-parameter-array reading unit 33. The multiview-depth-value restoring unit 15 outputs information of a set of the frame pixel index Fi included in the pixel index Gi and the depth value array, to the multiview depth-determining unit 16 (step S86).

The multiview depth-determining unit 16 performs the depth determining process explained with reference to FIG. 14, based on the information inputted from the multiview-depth-value restoring unit 15. The multiview depth-determining unit 16 relates a depth value E(n) that is determined to indicate a closer position than the depth value stored in the multiview-frame depth-value retaining unit 51, to the corresponding pixel of the drawing frame stored in the multiview-frame depth-value retaining unit 51, and stores the value. The multiview depth-determining unit 16 relates the color information corresponding to the frame pixel index Fi and the camera viewpoint Cn of the depth value E(n), to the corresponding pixel of the drawing frame stored in the multiview-frame color-information retaining unit 52, to be stored (step S87).

Based on the color information in units of pixels in the drawing frame corresponding to each camera viewpoint, the display controller 17 generates parallax images according to the number of the camera viewpoints Cn, i.e., multiview data corresponding to an entire frame including the multiview sprite data of the sprite area (step S88). The display controller 17 displays the multiview data on the display unit 3, to present the entire frame in a state where a three-dimensional video image is drawn at a part corresponding to the sprite area in the frame (step S89), and terminates the process.

When the present process is performed for plural pieces of integrated multiview sprite data, the depth determination is performed, and then plural sprites are correctly overlapped to present a three-dimensional image in the frame.

According to the third embodiment, the multiview sprite data including the sets of the sprite pixel index Si, and the multiview color information and the depth parameter array, related to one multiview sprite name, are read from the integrated multiview-sprite-data retaining unit 53. The depth values in units of pixels with respect to each viewpoint are handled in the state of the depth parameter array that is obtained by arranging parameters of the function E(n) as an approximate expression. Accordingly, the memory usage can be reduced, and the loads relating to the calculation can be suppressed. Thus, the depth values in units of pixels with respect to each viewpoint can be efficiently derived.

After the depth values are restored from the depth parameter array, the depth determination in units of pixels with respect to each viewpoint is performed. The multiview data that are drawn based on the color information in units of pixels with respect to each viewpoint obtained from a result of the determination are displayed on the display unit 3. Accordingly, a high-accuracy three-dimensional video image can be presented, and the accuracy of the approximation can be visually confirmed.

While the first to third embodiments have been explained above, the present invention is not limited thereto. Various modifications, substitutions, and additions can be made without departing from the scope of the present invention.

For example, programs for executing the processes in the multiview-data generating apparatus 100, 200, or 300 can be provided being recorded in a installable or executable form on a computer-readable recording medium such as a compact disk read only memory (CD-ROM), a floppy disk (FD, registered trademark), and a digital versatile disk (DVD).

The programs for executing the processes in the multiview-data generating apparatus 100, 200, or 300 can be stored in a computer that is connected to a network such as the Internet, and downloaded through the network.

In such a case, the programs are read from the recording medium and executed by the multiview-data generating apparatus 100, 200, or 300, to be loaded on the RAM 5. Accordingly, the components that have been described as the software configuration are generated on the RAM 5.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A multiview-data generating apparatus comprising:
a first receiving unit that receives an input of multiview camera information including at least information regarding plural different viewpoints and the number of pixels in a frame as a shooting range from each of the viewpoints;
a second receiving unit that receives an input of shape data representing a shape and a color of a computer graphic (CG) object;
a pixel index generator that successively generates a pixel index of each pixel included in a predetermined area in the frame;
a color information generator that generates, based on the multiview camera information and the shape data, a group of color information during shooting of the CG object placed within the frame from the respective viewpoints, for each of the pixel indexes;
a depth value generator that generates, based on the multiview camera information and the shape data, a group of depth values during shooting of the CG object placed within the frame from the respective viewpoints, for each of the pixel indexes;
a depth-parameter array generator that derives an approximate function by approximating a relation between the respective viewpoints and the group of the depth values, for each of the pixel indexes, and generates a depth parameter array by arranging parameters of the approximate function; and
a multiview data generator that generates multiview data corresponding to parallax images according to the number of viewpoints, based on the group of color information and the depth parameter array for each of the pixel indexes.

2. The apparatus according to claim 1, wherein the depth-parameter array generator defines a relation between the respective viewpoints and depth values included in the group of the depth values for each of the pixel indexes by a function using the viewpoint as a variable, and approximates the function to derive the approximate function.

3. The apparatus according to claim 1, further comprising:
a depth-value storage unit that stores the depth value in units of pixels included in each of drawing frames, with respect to the drawing frames prepared for the respective viewpoints; and
a color-information storage unit that stores the color information in units of pixels included in each of the drawing frames, with respect to the drawing frames prepared for the respective viewpoints, wherein
the multiview data generator includes:
a restoring unit that restores a set of the respective viewpoints and restored depth values for each of the pixel indexes, by assigning the depth parameter array to the approximate function;
a depth determining unit that compares the restored depth value for each viewpoint corresponding to each of the pixel indexes and a depth value of a pixel corresponding to the viewpoint and the pixel index stored in the depth-value storage unit, when the restored depth value is determined to indicate a closer position than the depth value stored in the depth-value storage unit, relates the restored depth value to a pixel of a drawing frame corresponding to the pixel index and the viewpoint of the restored depth value and stores in the depth-value storage unit, and relates the color information included in the color information group corresponding to the pixel index and the viewpoint of the restored depth value to the pixel of the drawing frame corresponding to the pixel index and the viewpoint and stores in the color-information storage unit; and
a generator that generates the multiview data based on the drawing frames stored in the color-information storage unit.

4. The apparatus according to claim 1, further comprising:
an integrated-data storage unit; and
a storage controller that relates integrated data to identification information for identifying the integrated data and stores in the integrated-data storage unit, for each the pixel index, the integrated data including the color information group and the depth parameter array corresponding to each of the pixel indexes, which are related to each other.

5. The apparatus according to claim 4, further comprising:
a depth-value storage unit that stores the depth value in units of pixels included in each of drawing frames, with respect to the drawing frames prepared for the respective viewpoints; and
a color-information storage unit that stores the color information in units of pixels included in each of drawing frames, with respect to the drawing frames prepared for the respective viewpoints, wherein
the multiview data generator includes:
a third receiving unit that receives input of display attribute information that specifies a part or all of the frame;
a fourth receiving unit that receives input of reading identification information as a reading target;
a reading unit that refers to integrated data having the identification information that matches the reading identification information, from the integrated data stored in the integrated-data storage unit, and successively reads the color information group and the depth parameter array for each pixel index of each pixel included in the area specified by the display attribute information;
a restoring unit that assigns the depth parameter array to the approximate function, and restores a set of the respective viewpoints and restored depth values for each of the pixel indexes;
a depth determining unit that compares the restored depth value for each of the viewpoints corresponding to each of the pixel indexes and a depth value of a pixel corresponding to the viewpoint and the pixel index stored in the depth-value storage unit, when the restored depth value is determined to indicate a closer position than a depth value stored in the depth-value storage unit, relates the restored depth value to a pixel of a drawing frame corresponding to the pixel index and the viewpoint of the restored depth value and stores in the depth-value storage unit, and relates color information included in the color information group corresponding to the pixel index and the viewpoint of the restored depth value to the pixel of the drawing frame corresponding to the pixel index and the viewpoint and stores in the color-information storage unit; and
a generator that generates the multiview data based on the drawing frames stored in the color-information storage unit.

6. The apparatus according to claim 3, wherein
the depth-value storage unit stores a depth value representing a infinite depth related to each pixel included in the drawing frame at an initial state, and
the color-information storage unit stores color information representing a background color of the drawing frame related to each pixel included in the drawing frame at the initial state.

7. The apparatus according to claim 5, wherein
the depth-value storage unit stores a depth value representing a infinite depth related to each pixel included in the drawing frame at an initial state, and
the color-information storage unit stores color information representing a background color of the drawing frame related to each pixel included in the drawing frame at the initial state.

8. The apparatus according to claim 3, further comprising:
a determination-expression storage unit that stores a depth-determination condition expression for determining an anteroposterior relation associated with a depth between the restored depth value and the depth value stored in the depth-value storage unit, wherein
the depth determining unit assigns to the depth-determination condition expression, the restores depth value for each viewpoint corresponding to each of the pixel indexes and a depth value of a pixel in the drawing frame stored in the depth-value storage unit and corresponding to the viewpoint and the pixel index, and makes the determination based on a result of calculation of the depth-determination condition expression.

9. The apparatus according to claim 5, further comprising:
a determination-expression storage unit that stores a depth-determination condition expression for determining an anteroposterior relation associated with a depth between the restored depth value and the depth value stored in the depth-value storage unit, wherein
the depth determining unit assigns to the depth-determination condition expression, the restores depth value for each viewpoint corresponding to each of the pixel indexes and a depth value of a pixel in the drawing frame stored in the depth-value storage unit and corresponding to the viewpoint and the pixel index, and makes the determination based on a result of calculation of the depth-determination condition expression.

10. A multiview-data generating method comprising:
first receiving an input of multiview camera information including at least information regarding plural different viewpoints and the number of pixels in a frame as a shooting range from each of the viewpoints;
second receiving an input of shape data representing a shape and a color of a computer graphic (CG) object;
successively generating a pixel index of each pixel included in a predetermined area in the frame;
generating, based on the multiview camera information and the shape data, a group of color information during shooting of the CG object placed within the frame from the respective viewpoints, for each of the pixel indexes;
generating, based on the multiview camera information and the shape data, a group of depth values during shooting of the CG object placed within the frame from the respective viewpoints, for each of the pixel indexes;
deriving an approximate function by approximating a relation between the respective viewpoints and the group of the depth values, for each of the pixel indexes, and generating a depth parameter array by arranging parameters of the approximate function; and
generating multiview data corresponding to parallax images according to the number of viewpoints, based on the group of color information and the depth parameter array for each of the pixel indexes.

11. A computer program product having a computer readable medium including programmed instructions for generating multiview-data, wherein the instructions, when executed by a computer, cause the computer to perform:
first receiving an input of multiview camera information including at least information regarding plural different viewpoints and the number of pixels in a frame as a shooting range from each of the viewpoints;
second receiving an input of shape data representing a shape and a color of a computer graphic (CG) object;
successively generating a pixel index of each pixel included in a predetermined area in the frame;
generating, based on the multiview camera information and the shape data, a group of color information during shooting of the CG object placed within the frame from the respective viewpoints, for each of the pixel indexes;
generating, based on the multiview camera information and the shape data, a group of depth values during shooting of the CG object placed within the frame from the respective viewpoints, for each of the pixel indexes;
deriving an approximate function by approximating a relation between the respective viewpoints and the group of the depth values, for each of the pixel indexes, and generating a depth parameter array by arranging parameters of the approximate function; and
generating multiview data corresponding to parallax images according to the number of viewpoints, based on the group of color information and the depth parameter array for each of the pixel indexes.
